(19) United States
(12) Patent Application Publication
(10) Pub. No.: US 2017/0368699 A1
(43) Pub. Date: Dec. 28, 2017

(54) Cutter Head For Personal Care Appliances

(71) Applicant: Braun GmbH, Kronberg (DE)

(72) Inventors: Christian Schuebel, Frankfurt am Main (DE); Martin Kluge, Floersheim am Main (DE); Martin Fuellgrabe, Bad Camberg (DE); Andreas Staub, Hettlingen (CH); Andreas Lauber, Zuerich (CH); August Enzler, Haslen (CH); Raymond Curtis, Uetikon am See (CH)

(21) Appl. No.: 15/619,601

(22) Filed: Jun. 12, 2017

(30) Foreign Application Priority Data
Jun. 24, 2016 (EP) 16176233.1

(51) Int. Cl. B26B 19/28; B26B 19/14; B26B 19/38

(52) U.S. Cl. CPC B26B 19/282; B26B 19/3886; B26B 19/386; B26B 19/3846; B26B 19/141; B26B 19/28; B26B 19/14; B26B 19/3853

(57) ABSTRACT

The present invention relates a tool head for a personal care appliance, including a plurality of tool rotors rotatably supported about rotor axes and a drive train for rotatably driving said tooling rotors from a motor, wherein such drive train includes: an input crank element having connection means for connecting to a drive shaft, a transmitter element configured to be driven by said input crank element, and output crank elements configured to be driven by said transmitter element to rotate about said rotor axis.

### FIELD OF THE INVENTION

The present invention relates to personal care appliances such as shavers, hair removal devices, skin peeling devices or toothbrushes having tools of the rotatory type. More particularly, the invention relates to a tool head for a personal care appliance, including a plurality of tooling rotors rotatably supported about rotor axes and a drive train for rotatorily driving said tooling rotors from a motor. The invention also relates to an electric shaver having a cutter head with a plurality of cutting rotors driven by a drive train connectable to a motor.

### BACKGROUND OF THE INVENTION

Electric shavers may have one or more rotatory cutter elements which may be driven in an oscillating or a continuous manner by an electric motor connected to the rotatory cutter elements through a drive train transmitting the rotation of the motor shaft to the rotatory cutter elements.

In cutter heads having a plurality of cutting rotors, the driving motion of the motor shaft of the electric motor needs to be distributed to said plurality of cutting rotors what can be achieved by a drive train having a common input element and a plurality of output elements connected to said common input element by means of transmission elements such as meshing gears, chain drive elements or belt drive elements. However, the higher the number of cutting rotors in the cutter head, the more complex the drive train and the higher the number of drive train elements. This may cause problems with accommodating the drive train elements in the cutter head which should have a small size to allow for easy handling of the appliance. In addition, such drive trains are rather noisy in operation due to the meshing gears or the chain engaging with the sprocket wheels.

For example, EP 15 87 651 B1 shows an electric shaver having three cutting rotors driven by an electric motor via a drive train having a central gear wheel which, on the one hand, is driven by a pinion connected to the motor shaft and, on the other hand, drives three output gear wheels connected to the cutting rotors via output shafts. Although there are only three cutting rotors, there is quite some space needed in the cutting head to accommodate the various gear wheels of the drive train.

A similar electric shaver is shown by EP 17 61 367 B1, wherein each of the cutting rotors is connected to the output drive shaft by means of a sort of ball and socket joint allowing for tilting movements of the cutting rotor to adapt to the skin contour, wherein viscoelastic elements are provided for elastically urging the cutting rotors to the skin surface.

An electric shaver having more than three cutting rotors is known from CN 101041237 A, wherein a plurality of cutting rotors are positioned along a circle around a central cutting rotor so that in total seven cutting rotors are arranged on the cutter head surface.

### SUMMARY OF THE INVENTION

It is an objective underlying the present invention to provide for an improved personal care appliance and an improved tool head for such personal care appliance avoiding at least one of the disadvantages of the prior art and/or further developing the existing solutions. A more particular objective underlying the invention is to provide for an improved transmission architecture for transmitting the drive unit's action to the plurality of tooling rotors, wherein noise emissions from the drive train are low and power dissipation of the transmission structure is low. Another objective underlying the present invention is to allow for a space saving, compact drive train structure that can be accommodated within a small-sized tool head even when such tool head includes a rather high number of tooling rotors such as five, seven or ten or even more tooling rotors. A still further objective underlying the invention is to achieve smooth and quiet running of the drive train with low vibrations.

To achieve at least one of the aforementioned objectives, the drive train may provide for an input crank element having connection means for connecting to a drive shaft, a transmitter element configured to be driven by said input crank element, and a plurality of output crank elements configured to be driven by said transmitter element to rotate about the rotor axes of the tool rotors and to rotatorily drive the tool rotors about said rotor axes. Said transmitter element distributes the driving action of the input crank element to the output crank elements, wherein said input crank element transforms the rotatory movement of the drive shaft into a revolving or orbiting movement of the transmitter element which is again retransformed into a rotatory movement by means of the output crank elements to rotatorily drive the tooling rotors.

Distributing the rotation of a drive shaft to a plurality of rotors through a crank mechanism allows for a simple and compact drive train architecture even when a large number of rotors are to be driven, wherein a large design freedom in positioning and varying the number of rotors is achieved. In addition, due to the crank mechanism transmitting the driving action of the common drive shaft to the plurality of rotors, a low noise operation with low vibrations can be achieved. More particularly, noise and vibrations caused by teeth of gear wheels and chain elements getting into engagement and getting out of engagement can be avoided.

These and other advantages become more apparent from the following description giving reference to the drawings and possible examples.

### BRIEF DESCRIPTION OF THE DRAWINGS

FIG. 1 is a perspective view of an electric shaver having a cutter head including a plurality of cutting rotors that can be rotatorily driven from a motor in the handpiece of the shaver via a drive train connecting the motor to the cutting rotors,

FIG. 2 is a partial, enlarged perspective view of the cutter head of the electric shaver of FIG. 1, showing the cutting rotors arranged in three rows having more than three rotors each,

FIG. 3 is a schematic, cross-sectional view of the cutter head of the electric shaver of FIGS. 1 and 2, wherein the drive train including the input crank element, the transmitter element and the plurality of output crank elements are shown,

FIG. 4 is a perspective view of the drive train showing the parallel arrangement or orientation in the same direction of the crank elements for achieving a compensation of unbalanced masses and flyweights to achieve smooth running with low vibrations,

FIG. 5 is a cross-sectional view of the drive train similar to FIG. 3, wherein the kinetic forces of the running drive train elements are illustrated,

FIG. 6 is a cross-sectional view of a crank element having an overload clutch,

FIG. 7 shows the electric shaver of FIG. 1 in different views corresponding to different mounting stages of the cutter head.

### DETAILED DESCRIPTION OF THE INVENTION

In order to transmit the driving action of a drive shaft which may be the motor shaft of an electric motor or may be connected thereto by means of intermediate transmission elements, to a plurality of tooling rotors in the tooling head of a personal care appliance, the drive train connecting said drive shaft to the plurality of tooling rotors and distributing the driving torque of the drive shaft to each of the plurality of tooling rotors includes a crank mechanism comprising an input crank element having connection means for connecting to said drive shaft, a transmitter element configured to be driven by said input crank element and a plurality of output crank elements configured to be driven by said transmitter element to rotate about the rotor axes of said plurality of tooling rotors. Said tooling rotors may be connected to the rotating portions of the output crank elements in a torque-transmitting way. The input crank element may transform the rotation of the drive shaft into a revolving or orbiting, in particular circular movement of the transmitter element which orbiting movement is retransformed into a rotation of a shaft by means of said plurality of output crank elements driving the plurality of tooling rotors.

Said transmitter element forms a distributor distributing the action of the input crank element to the plurality of output crank elements and may have a substantially plate-like shape allowing for a thin, space-saving structure of the drive train and arrangement of the plurality of output crank elements, wherein such output crank elements may be arranged in different layout configurations. In particular, the positioning of the output crank elements and thus, the tooling rotors is not restricted to a circular arrangement where the tooling rotors are arranged along a circle about a center axis of the tooling head, but the output crank elements and the tooling rotors may be positioned in lines and rows like a matrix, or in a cloud-like distribution not conforming to a regular matrix, or in mixed positionings where a part of the rotors is positioned in a regular matrix and another part of the rotors and output crank elements is arranged in an irregular, cloud-like manner with different, non-uniform spacings therebetween.

The transmitter element, however, does not need to have a plate-like shape in terms of a plane plate in a mathematical sense, but it may have curvature and/or variations in thickness and/or recesses and other voids like a frame structure. For example, the transmitter element may be a thin body having a thickness significantly smaller than its extensions in two other axes. More particularly, the plate-like body may have a slightly curved shape about one axis like a wagon roof or about two axes like a dome-shaped roof, or may have a free formed curvature so as to adapt to the contour of the tooling head, more particularly to the contour of the field of tooling rotors. In the alternative, the transmitter element may have the shape of a plane plate, or a combination of plane portions and curved portions.

The transmitter element may include a plurality of connectors for rotatably connecting the output crank elements and the input crank element to said transmitter element. Said crank-connectors of the transmitter element may include receiving recesses therein such as bores or through-holes or pocket holes for rotatably receiving crank connection pins of said output and/or input crank elements. In a sort of kinematic reversion, the transmitter element may include connector pins forming the crank connectors of the transmitter element, which connector pins of the transmitter element may engage with recesses in the crank elements which may include bores or holes that can be rotatably fitted onto the connector pins.

Advantageously, the crank connectors of the transmitter element and the crank elements form a rotatory bearing allowing the crank elements to rotate relative to the transmitter element. Such rotatory bearings may be configured as friction bearing or sliding bearing supporting the transmitter element onto the crank elements.

Said transmitter element may be supported only by said crank elements, i.e. the input crank element and/or the output crank elements. More particularly, one may dispense with any additional bearings or supports for the transmitter element which is only held by the rotatory engagement with the input and output crank elements. Such floating or flying support of the transmitter element provides for a lightweight, compact and space-saving arrangement allowing for a thin, compact structure of the tooling head.

The aforementioned output and/or input crank elements themselves may be rotatably supported on a frame of the tool head, wherein all output crank elements may be supported on a common first frame portion and the input crank element may be supported on a second frame portion which first and second frame portions may be formed separately from each other or, in the alternative, may be part of the same common frame. In particular, said frame portions may be spaced from each other so that the transmitter element may be positioned in between said two frame portions. Also, the input and output crank elements may be positioned between said two frame portions, thus providing for a sort of sandwich structure where the input and output crank elements and the transmitter element connected thereto are sandwiched between two frame portions of the tool head. Such sandwiched frame structure allows for a premounted head structure which can be attached and detached to and from a handpiece of the personal care appliance.

Each of the input and output crank elements may be supported rotatably about a crank rotation axis fixed to the frame of the tool head so that each of the input and output crank elements may rotate about a fixed crank rotation axis relative to the body of the tool head.

The aforementioned crank rotation axes of the crank elements may extend in parallel to each other and/or in parallel to the axes of rotation about which the crank elements may rotate relative to the transmitter element. Arranging the crank rotation axes parallel to each other allows for easy configuration of the connection between the transmitter element and the respective crank elements. To avoid jamming of the crank mechanism, the crank elements may engage the transmitter element with play and/or may be loosely connected to the transmitter element. For example, the transmitter element may have bores or holes oversized a bit with regard to the pins of the crank elements received therein so that the connection between the transmitter element and the output crank elements may provide for some play. Such loose fit of the input and/or output crank elements to the transmitter element also may be provided when all crank rotation axes are arranged exactly in parallel to each other. By means of such play between the crank elements and the transmitter element, manufacturing tolerances may be compensated and a smooth running and engaging of the drive train elements may be ensured. In particular, the output crank elements may be connected to the transmitter element with play transverse to the axes of rotation of the output crank elements.

Said plurality of output crank elements may have the same orientation and/or lever arms of said output crank elements may have longitudinal extensions parallel to each other. For example, in a specific phase of operation, all output crank elements may be oriented towards 3 o'clock, whereas in another phase of operation they may be oriented towards 6 o'clock. In other words, rotation of the output crank elements may be synchronized to extend in the same directions. The aforementioned lever arm of a crank element may be considered the linear connection between the crank rotation axis about which the crank element is rotatably supported on the tool head frame, to the axis of rotation about which the crank element is rotatably supported to the transmitter element.

The orientation of the input crank element may be aligned with, in particular parallel to the orientation of the output crank elements. For example, when the lever arm of the input crank element going from the crank rotation axis fixed to the frame to the axis of rotation fixed to the transmitter element, is oriented towards 6 o'clock, the lever arms of the output crank elements also may be oriented towards 6 o'clock.

Said output crank elements and said input crank element may have crank levers of substantially the same lever length.

In order to achieve a specifically smooth and quiet running of the crank mechanism with very low vibrations, the transmitter element and the output and input crank elements may be designed in terms of their mass and/or in terms of the positioning of their center of gravity relative to their rotation axis such that the centrifugal forces of the input and output crank elements may be compensated by the centrifugal force of the transmitter element. Going on the assumption that the centrifugal force of the transmitter element goes into a direction opposite to the centrifugal forces of the input and output crank elements, the design of the input and output crank elements and the transmitter element, in particular the mass of the input and output crank elements and the mass of their transmitter element and the distance of the center of gravity of the input and output crank elements from the axis of rotation thereof and the distance of the center of gravity of the transmitter element from the center of rotation thereof can be chosen such that the respective centrifugal forces substantially compensate each other.

More particularly, going on the assumption that the centrifugal forces are balanced when the equation

Fₚₗₐₜₑ=F_{motorcrank}+n·F_{crank}

is fulfilled, the aforementioned parameters mass and distance of the center of gravity of the respective element from the axis of rotation thereof can be derived from the equation defining the centrifugal force of each element

Fₓ=ω²·mₓ·rₓ

with Fₓ being the centrifugal force of an element x (such as the crank element or transmitter element), ω being the angular velocity, mₓ being the mass of the respective element x and rₓ being the distance of the center of gravity of a respective element x from the axis of rotation thereof. As all elements rotate at the same angular speed, ω applies to all elements.

In order to achieve a compensation or at least reduction of unbalanced mass or flyweight, the sum of the torques of the output crank elements relative to the transmitter element may be balanced by the torque of the input crank element relative to the transmitter element. To achieve such compensation, the aforementioned parameters mₓ and rₓ representing mass and distance of center of gravity from axis of rotation of a respective element, may be chosen such that the following equation is fulfilled:

n·F_{crank}·a=F_{motorcrank}·b,

with n being the number of output crank elements, F_{crank} being the centrifugal force of an output crank element, a being the distance of the crank portions of the output crank elements from the transmitter element, more particularly the distance of the center of gravity of the output crank elements from the center of gravity of the transmitter element, and b being the distance of the input crank element from the transmitter element, more particularly the center of gravity of the input crank element from the center of gravity of the transmitter element and F_{motorcrank} being the centrifugal force of the input crank element.

The aforementioned parameter mass m can be adjusted by means of different materials and/or different thickness of the elements and/or different dimensions of the elements. The aforementioned parameter distance r of the center of gravity from the axis of rotation as well as the parameters a and b may be adjusted by means of varying the geometry of the elements.

In order to avoid jamming or sticking of the entire crank mechanism and drive train due to jamming or blocking of one of the tool rotors which may occur when the respective tool rotor engages an obstacle and/or is pressed onto the surface to be treated with a contact pressure too high, a torque release device or a clutch device may be provided between the tooling rotor and the output crank element. For example, such torque release device or overload clutch may be integrated into the output crank elements, more particularly into the shaft portion of the output crank elements to which the tooling rotor is connected. If the tooling rotor is blocked or the rotational resistance of the tooling rotor becomes too high, such torque release device may allow the output crank element to rotate relative to the tooling rotor.

Such torque release device or overload clutch may be a friction clutch having two clutch elements locked with each other as long as the torque to be transmitted is below a certain threshold and, on the other hand, are allowed to rotate relative to the each other when the torque to be transmitted through the clutch exceeds a certain threshold. Such torque release mechanism may be achieved by means of friction elements elastically urged towards each other. In addition or in the alternative, magnetic forces may hold or release said two clutch elements.

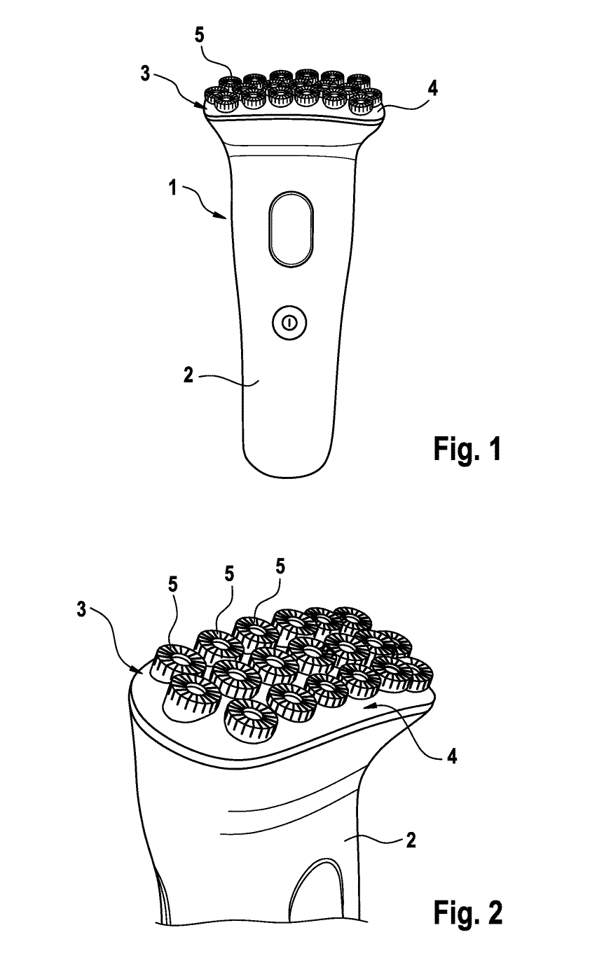

These and other features become more apparent from the examples shown in the drawings. As can be seen from FIG. 1, the appliance may be a handheld personal care appliance in terms of, for example, a shaver 1 having an appliance housing 2 forming a handpiece for holding the appliance, which housing 2 may have different shapes such as—roughly speaking—a substantially cylindrical shape or box shape or bone shape allowing for ergonomically grabbing and holding the appliance, wherein such housing 2 may have a longitudinal housing axis due to the elongated shape thereof, cf. FIG. 1.

On one end of the housing 2, a tool head 3 in terms of a cutter head may be attached to the housing 2, wherein such tool head 3 may be pivotably supported about one or more tilting axes allowing for tilting adaption of the tool head 3 to the surface to be treated, i.e. the skin to be shaved without tilting the housing 2.

On its functional surface 4, the tool head 3 may have a plurality of tooling rotors 5 which may be embedded in or projecting from the tool functional surface 4. When the appliance is a shaver, said tooling rotors 5 may be cutting rotors for cutting hairs, wherein such cutting rotors 5 may include a plurality of blades or shearing edges cooperating with a perforated shear foil covering said cutting rotors 5.

As can be seen from FIG. 2, said tooling rotors 5 may be arranged—roughly speaking—in a common plane, wherein more particularly the tooling rotors 5 may be positioned along the functional surface 4 of the tool head 3 which functional surface 4 may have a slightly curved, in particular convex shape to better adapt to the surface to be treated. When the tooling rotors 5 project from said functional surface 4 by the same amount, i.e. the tooling rotors 5 have the same heights above said functional surface 4, the tooling rotors 5, with their front faces, define an enveloping surface or working surface corresponding in shape and contour to said functional surface 4. In other words, the tooling rotors 5 may have different heights or extensions in their axes of rotation to define different rotor field contours or rotor field surfaces such as a convex surface, a concave surface, a plane surface or mixtures thereof to achieve better adaption to the contour of the skin area to be shaved. As can be seen from FIG. 2, the tooling rotors 5 may be positioned in a plurality of rows one above the other, each row comprising a plurality of tooling rotors 5. Other positioning of the tooling rotors 5 are possible.

For example, three tooling rotors 5 may be provided. However, it is also possible to have more than three, in particular more than five tooling rotors 5. As can be seen from FIG. 2, also more than ten or more than fifteen tooling rotors 5 can be arranged on the tool head 3.

Each of the tooling rotors 5 can be rotatorily driven about a rotor axis 21, which rotor axes 21 can be arranged parallel to each other, in particular substantially perpendicular to the plane or perpendicular to the functional surface 4 of the tool head 3. Such rotor axes 21 may extend through the center of the tooling rotors 5 and/or may form an axis of symmetry of such rotors 5, wherein more particularly such rotor axis may extend substantially perpendicular to the engagement surface of the tooling rotors contacting the surface to be treated.

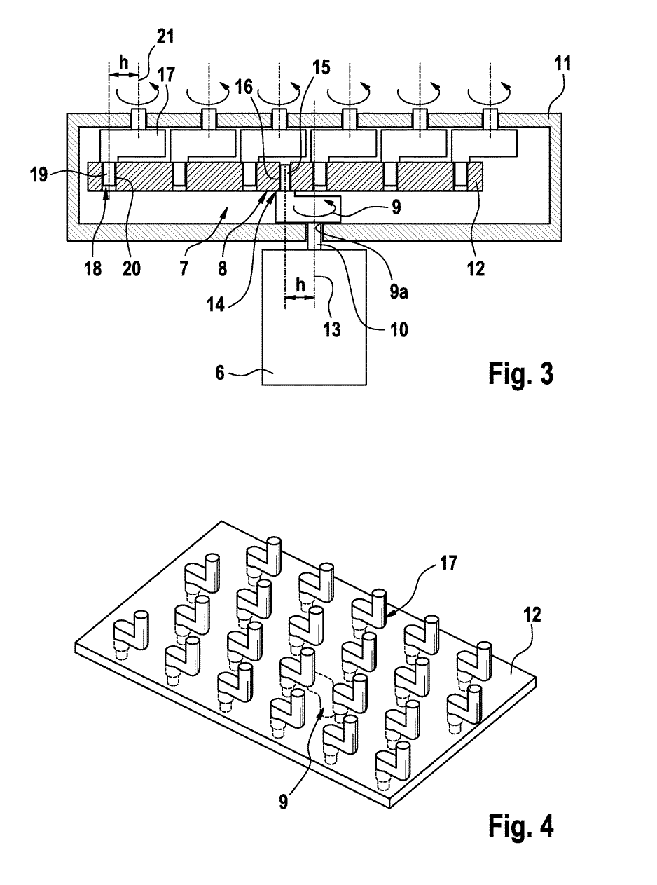

So as to rotatorily drive said tooling rotors 5, a motor 6 which may be an electric motor arranged in the housing 2 forming the handpiece of the appliance, may be connected to the tooling rotors 5 by means of a drive train 7 which is shown in FIG. 3. Such drive train 7 may include a crank mechanism 8 including an input crank element 9 transforming the rotation of a drive shaft 10 which may be the motor shaft of the motor 6 or an intermediate shaft coupled thereto, into a cranking movement or circular, orbiting movement about the axis of rotation 13 of said drive shaft 10. Said input crank element 9 may be rotatably supported at a frame portion of a frame 11 or a structural element of the tool head 3.

More particularly, the said input crank element 9 may drive a transmitter element 12 which may have a plate-like shape and/or a substantially flat body with main extension axes extending substantially transverse to the axis of rotation 13 of the input crank element 9. As can be seen from FIG. 3, the transmitter element 12 includes a crank connector which is rotatably connected to the input crank element 9. Said crank connector may form a rotatable bearing 14 in terms of, e.g., pin connection comprising an eccentric crank pin 15 rotatably received within a recess 16 in said transmitter element 12. The eccentric position of said crank pin 15 defines the lever arm h which corresponds to the distance of said crank pin 15 from the axis of rotation 13 of the input crank element 9. Advantageously, the axis of rotation of rotatable bearing 14 is substantially parallel with the axis of rotation 13 of the input crank element 9 relative to frame 11.

Due to the driving motion of the input crank element 9, the transmitter element 12 executes an orbiting or revolving movement along a circle about the axis of rotation 13 of input crank element 9.

Such movement of the transmitter element 12 is transmitted onto output crank elements 17 which are, on the one hand, rotatably connected to the transmitter element 12 and, on the other hand, rotatably supported by a frame portion of frame 11 of the tool head 3 or other structural elements of said tool head 3.

Similar to the input crank element 9, said output crank elements 17 are rotatably connected to the transmitter element 12 by means of rotatable bearings 18 which may be formed by crank pins 19 rotatably received in recesses 20 in the transmitter element 12. As can be also seen from FIG. 3, said output crank elements 17 are rotatably supported by frame 11 about axes of rotation 21 which are substantially parallel to each other and/or substantially parallel to the axis of rotation 13 of input crank element 9. Said axes of rotation 21 of the output crank elements 17 may extend coaxially to the rotor axes of the tooling rotors 5.

The crank pins 19 connecting the output crank elements 17 to the transmitter element 12 may be positioned eccentric with regard to the axes of rotation 21 of the output crank elements 17, wherein the distance between the crank pins 19 from the axes of rotation 21, i.e. the eccentricity of the crank pins 19 define the lever arms of the output crank elements 19, which lever arm h may correspond to the lever arm h of the input crank element 9.

As indicated by the arrows in FIG. 3, the input crank element 9 and the output crank elements 17 may rotate in the same direction and/or at the same rotational speed and/or in synchronized fashion relative to each other.

As can be seen from FIG. 4, the output crank elements 17 advantageously can be positioned and/or oriented in a way corresponding to each other. More particularly, the lever arms h of the output crank elements 19 may have the same orientations and/or may define longitudinal axes parallel to each other.

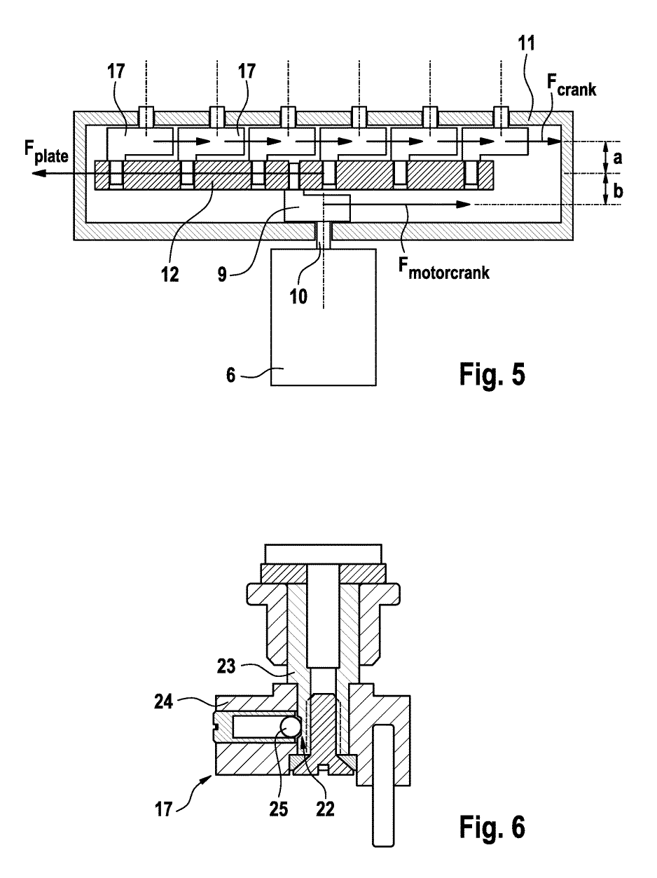

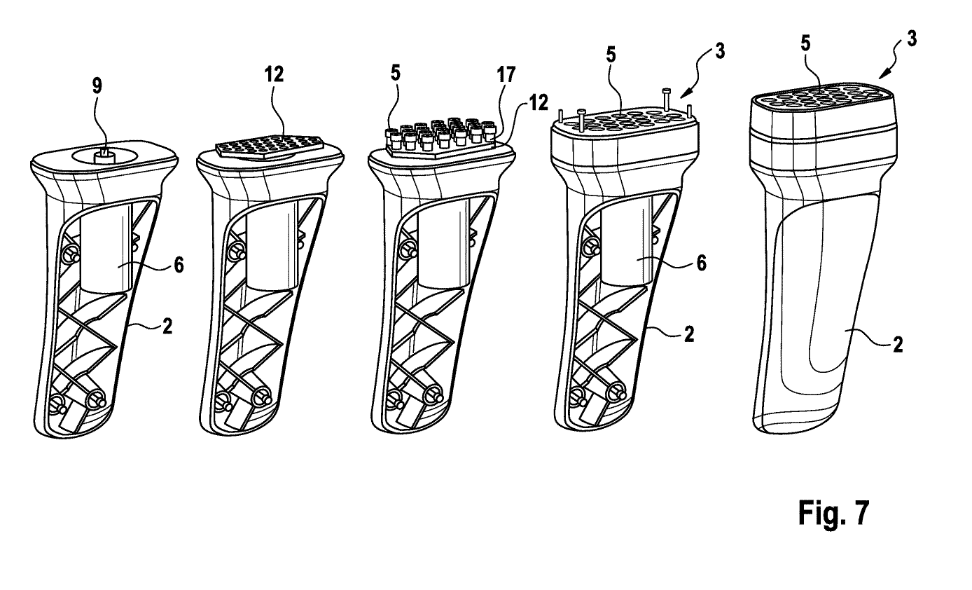

The input crank element 9 may have an orientation identical to the orientation of the output crank elements 17. More particularly, the lever arm h of the input crank element 9—one considering such lever arm going from the axis of rotation 13 to the crank pin 15—may extend in a direction parallel to the direction of the lever arms of the output crank elements 17 going from the respective axes of rotation 21 to the crank pin 19 thereof, cf. FIGS. 3 and 5.

So as to avoid jamming of the crank mechanism due to the various axes of rotation of the output crank elements 17, the rotatable bearings 18 connecting the output crank elements 17 to the transmitter element 12 may provide for some play transverse to the axis of rotation. More particularly, the recesses 20 in the transmitter elements 12 in which the crank pins 19 of the output crank elements 17 are received, may be a bit oversized to provide for a loose engagement of the crank pins 19. Such play of the crank pins 19 in the recesses 20 may compensate manufacturing tolerances and/or some inclination of the axes of rotation 21 of the output crank elements 19 relative to the each other.

According to an advantageous aspect, the transmitter element 12 and the output and input crank elements 17 and 9 may be designed in terms of their mass and geometry to substantially balance the torques of the output crank elements 17 onto the transmitter element 12 against the torque of the input crank element 9 onto the transmitter element 12 and the centrifugal force of the transmitter element against the centrifugal forces of the input and output crank elements when running at any speed. In particular, the transmitter element, the input crank element and the output crank elements may be adapted such that the following equation is fulfilled:

Fₚₗₐₜₑ=F_{motor crank}+n·F_{crank},

with Fₚₗₐₜₑ being the centrifugal force of the transmitter element, F_{motor crank} being the centrifugal force of the input crank element and F_{crank} being the centrifugal force of each of the output crank elements.

This desired compensation of the centrifugal forces can be achieved by means of choosing the mass and distance of the center of gravity of the transmitter element 12 and the crank elements 9, 17, respectively, with the help of the following equation:

Fₓ=ω²mₓrₓ,

with Fₓ being the centrifugal force of an element x (meaning the transmitter element 12, the input crank element 9 or the output crank element 17), ω being the angular speed of all elements and rₓ being the distance of the center of gravity of a respective element from the rotational axis thereof.

The said parameters mass mₓ and eccentricity rₓ of the center of gravity can be adjusted by means of choosing the material and adapting the geometry of the elements appropriately.

Thus, the static flyweight of the transmitter element may be compensated or at least significantly reduced.

In order to compensate for the dynamic flyweight and torques of the input and output crank elements 9 and 17, said input and output crank elements 9 can be designed such that the following equation is fulfilled:

n·F_{crank}·a=F_{motorcrank}·b,

with n being the numbers of output crank elements 17, F_{crank} being the centrifugal force of the output crank element 17, a being the distance of the center of gravity of the respective output crank element 17 from a plane going through the center of gravity of the transmitter element 12 perpendicular to the axis of rotation thereof, F_{motorcrank} being the centrifugal force of the input crank element 9 and b being the distance of the center of gravity of the input crank element 9 from the aforementioned plane containing the center of gravity of the transmitter element 12, cf. FIG. 5.

Again, compensation of the dynamic flyweight and the torques of the crank elements relative to each other, may be achieved by varying mass m and eccentricity r of the elements and distances a and b by means of adjusting material and geometry of the elements such that the aforementioned equation is fulfilled.

As can be seen from FIG. 6, the output crank elements 17 may include an overload clutch 22 allowing for rotation of the output crank element 17 relative to the tool rotor 5 attached thereto when a predetermined rotational resistance of the tooling rotor 5 is achieved or exceeded. Such overload clutch 22 may include a rotor piece 23 which is rotatably connected to a body piece 24 of the respective output crank element 17, wherein such rotor piece 23 may rotate relative to body piece 24 about a clutch axis substantially coaxial with the axis of rotation 21 of the output crank element 17 and/or coaxial to the rotor axis of the tooling rotor 5. In order to avoid such rotation of the rotor piece 23 of the overload clutch 22 relative to body piece 24 under normal conditions, a rotation preventer 25 may be associated with the rotor piece 23 and/or the body piece 24. Such rotation preventer 25 may include frictional engagement pieces attached to the rotor piece 23 and the body piece 24 and urged against each other. Other rotation preventers such as magnetic elements may be provided.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A tool head for a personal care appliance, including a plurality of tool rotors rotatably supported about rotor axes and a drive train for rotatably driving said tooling rotors from a motor, wherein such drive train includes:
an input crank element having connection means for connecting to a drive shaft,
a transmitter element configured to be driven by said input crank element, and
a plurality of output crank elements configured to be driven by said transmitter element to rotate about said rotor axis.

2. The tool head according to claim 1, wherein said transmitter element has a plate-like contour and/or a flat body with main extension axes transverse to the rotor axis, wherein said transmitter element includes a plurality of crank connectors for rotatably connecting said output crank element and said input crank element to said transmitter element.

3. The tool head according to claim 2, wherein said crank connectors of the transmitter element include receiving recesses therein such as bores for rotatably receiving crank connection pins attached to the input crank element and output crank elements.

4. The tool head according to claim 1, wherein said transmitter element is supported only by the output crank elements and/or said input crank element.

5. The tool head according to claim 1, wherein said output crank elements and said input crank element are rotatably supported about crank rotation axes parallel to each other and/or supported by a common tool head frame.

6. The tool head according to claim 1, wherein said output crank elements are connected to the transmitter element with play allowing playing movements of the output crank elements relative to the transmitter element transverse to the axis of rotation of said output crank elements.

7. The tool head according to claim 1, wherein said output crank elements and said input crank element have crank lever arms (h) of substantially the same lever length.

8. The tool head according to claim 1, wherein all output crank elements and the input crank element have the same orientation and/or have lever arms (h) having longitudinally extensions parallel to each other.

9. The tool head according to claim 1, wherein the transmitter element and the output and input crank elements are designed in terms of their mass (m) and their eccentricity (r) of their center of gravity from the rotation axis such that the centrifugal force of the transmitter element is compensated by the centrifugal forces of the input and output crank elements.

10. The tool head according to claim 9, wherein the transmitter element and the input and output crank elements are designed to fulfill the following equations:
Fₚₗₐₜₑ=F_{motorcrank}+n·F_{crank}, 1)
Fₓ=ω²mₓrₓ, 2)
with Fₚₗₐₜₑ being the centrifugal force of the transmitter element, F_{motorcrank} being the centrifugal force of the input crank element, n being the number of the output crank elements and F_{crank} being the centrifugal force of an output crank element, ω being the angular speed, mₓ being the mass of an element x, rₓ being the eccentricity of the center of gravity of an element x from the axis of rotation thereof and Fₓ being the centrifugal force of an element x, with x standing for anyone of the input crank element, the output crank element and the transmitter element.

11. The tool head according to claim 9, wherein the input crank element and the output crank elements are designed to fulfill the following equation:
n·F_{crank}·a=F_{motorcrank}·b, 3)
with n being the number of output crank elements, F_{crank} being the centrifugal force of an output crank element, a being the distance of the center of gravity of an output crank element from a plane extending perpendicular to the drive shaft and containing the center of gravity of the transmitter element, F_{motorcrank} being the centrifugal force of the input crank element and b being the distance of the center of gravity of the input crank element from said plane extending perpendicular to the drive shaft and containing the center of gravity of the transmitter element.

12. The tool head according to claim 1, wherein at least one of the tooling rotors is connected to the associated output crank element via an overload clutch allowing for rotation of the output crank element relative to the tooling rotor when a predetermined torque and/or a predetermined rotatory resistance of the tooling rotor is exceeded.

13. The tool head according to claim 12, wherein said overload clutch is integrated into said output crank element and/or includes a rotor piece in frictional engagement with a torque transmitting body piece of the output crank element.

14. The tool head according to claim 1, wherein it includes more than three or more than five or more than ten tooling rotors.

15. A Personal care appliance comprising the tool head comprising a plurality of tool rotors rotatably supported about rotor axes and a drive train for rotatably driving said tooling rotors from a motor, wherein such drive train comprises:
an input crank element having connection means for connecting to a drive shaft,
a transmitter element configured to be driven by said input crank element, and
a plurality of output crank elements configured to be driven by said transmitter element to rotate about said rotor axis, and a housing forming a handpiece and supporting said tool head.

16. The personal care appliance according to claim 15, wherein said housing accommodates a motor for driving the tooling rotors via the drive train.

17. The personal care appliance according to claim 15, wherein said appliance is formed as an electric shaver.
